(19) United States
(12) Patent Application Publication
(10) Pub. No.: US 2019/0360891 A1
(43) Pub. Date: Nov. 28, 2019

(54) SYSTEM FOR THE STATE MONITORING OF A FIBRE COMPOSITE STRUCTURE

(71) Applicant: Airbus Operations GmbH, Hamburg (DE)

(72) Inventors: Peter LINDE, Hamburg (DE); Karim GRASE, Hamburg (DE)

(21) Appl. No.: 16/420,295

(22) Filed: May 23, 2019

(30) Foreign Application Priority Data
May 25, 2018 (DE) 102018208254.5

(51) Int. Cl. G01M 5/00; H02S 40/38; B64F 5/60

(52) U.S. Cl. CPC G01M 5/0041; H01M 10/465; B64F 5/60; H02S 40/38

(57) ABSTRACT

A system for the state monitoring of a fiber composite structure, in particular of an aircraft or spacecraft, include a fiber composite structure; a multiplicity of state sensors which, on and/or in the fiber composite structure, are configured to detect state data of the fiber composite structure an energy store configured to store electrical energy for the supply of the state sensors in a rechargeable manner; an energy generating layer configured, on the fiber composite structure, to generate the electrical energy for the supply of the state sensors; and a data processing unit configured for wireless data communication with the state sensors for the further processing of the detected state data.

### RELATED APPLICATION

This application claims priority to German Patent application DE 102018208254.5 filed May 25, 2018, the entirety of which is incorporated by reference.

### FIELD OF THE INVENTION

The present invention relates to a system for the state monitoring of a fiber composite structure. In particular, the present invention is concerned with a system for the state monitoring of a fiber composite structure of an aircraft or spacecraft.

### BACKGROUND

Although usable in diverse applications, the present invention and the problem addressed thereby will be explained in greater detail with reference to passenger aircraft. However, the methods and devices described can likewise be used in different vehicles and in all areas of the transport industry, for example for road vehicles, for rail vehicles, for aircraft or for watercraft.

European Patent Application EP 3 222 514 A1 describes a skin panel laminate for an aircraft or spacecraft, wherein one or more functional layers are embedded between two structural layers. In particular, an energy storage layer in the form of a structural electrochemical battery is provided as a functional layer. In configurations, the functional layers can furthermore comprise an energy generating layer in the form of a photovoltaic module, an electrical actuator layer and a structure monitoring layer having a multiplicity of sensors for monitoring structural parameters of the skin panel laminate. In this case, the actuator layer and the structure monitoring layer are supplied with electrical energy by the energy generating layer, in particular.

### SUMMARY OF THE INVENTION

Against this background, the present invention may be used to find an autonomous, flexible and cost effective solutions for state monitoring of fiber composite structures.

A novel system has been invented and is disclosed herein for the state monitoring of a fiber composite structure. The system comprises a fiber composite structure; a multiplicity of state sensors which, on and/or in the fiber composite structure, are configured to detect state data of the fiber composite structure; an energy store configured to store electrical energy for the supply of the state sensors in a rechargeable manner; an energy generating layer configured, on the fiber composite structure, to generate the electrical energy for the supply of the state sensors; and a data processing unit configured for wireless data communication with the state sensors for the further processing of the detected state data.

The invention may be incorporated in an aircraft or spacecraft

One concept underlying the present invention consists in creating a state monitoring system that is autonomous and may be configured for structure monitoring, such as monitoring fiber composite components by sensors linked via a wireless data connection, wherein the electrical energy needed for operating the sensors is generated and provided in situ. Long data and/or power cables can be avoided in this way, whereby material, costs and weight can in turn be saved.

The invention affords advantages in particular for the monitoring of large area or large volume fiber composite components, Conventional approaches involve large, sensitive and error susceptible networks of data and/or power cables over the area or volume to be monitored. The present invention opens up the possibility of generating the electrical energy where it is required, without the need for long power lines to deliver electrical power. Power lines have to be integrated only locally and spatially in a highly restricted manner between the energy generating layer and/or the energy store and the state sensors.

Similarly, the needed for data cables can be significantly reduced or eliminated by the use of wireless communications between the sensors and the data processing units. The sensors may detect state data may such as of structural parameters of the fiber composite structure, which may be data on temperature, mechanical load and/or stress, and other parameters. Wireless transmission of the state data from the sensors to the data processing unit allows the unit to be arranged remotely at a distance of a few meters from the state sensors, e.g. at a distance of 10 to 30 meters.

The energy generating layer can be used for charging the energy store, which can in turn bridge momentary failures or a momentary non availability of the energy generating layer by virtue of the electrical energy stored there being used for operating the sensors.

A particularly flexible monitoring system with autonomous power supply and wireless data transmission is created as a result. By way of example, small groups of two to four or more sensors can be arranged in a manner distributed over a fiber composite structure and can be connected in each case to a local energy generating layer and/or a local energy store. Each of these groups can be supplied with electrical energy independently of the other groups in this way. Furthermore, each group can be wirelessly linked to a central data processing unit of the system. In principle, however, the groups can likewise communicate wirelessly among one another, e.g. via a wireless data network provided for this purpose.

In accordance with one development, the energy generating layer can be configured as a polymeric thin film solar cell. Solar cells of this type can be fabricated such that they are considerably thinner and more lightweight than conventional, crystalline solar cells and nevertheless have a large area. By virtue of the reduced use of material, thin film solar cells are more expedient to produce than crystalline solar cells. Furthermore, the solar cells can either be incorporated directly as large area, optionally curved layers into a fiber composite laminate during fiber composite fabrication. Alternatively or additionally, thin film solar cells can subsequently be cohesively connected to a finished fiber composite to form an integral structure, e.g. by means of an adhesive bonding method and/or a molding method. Moreover, modern thin film solar cells offer an outstanding efficiency and a correspondingly good energy efficiency.

In accordance with one development, the energy generating layer can be fabricated integrally with the fiber composite structure. By way of example, the energy generating layer can be incorporated as one or more laminate layers into a fiber composite laminate, e.g. in the course of an automated fiber placement (AFP) or automated tape laying (ATL) method or the like. In methods of this type, more or less thin, fibre reinforced tapes with or without a plastic matrix or other materials are placed along a predefined path on a tool surface by a laying head, which can be robot guided, with application of pressure and temperature. In this case, the fiber composite tapes can be placed in particular in a curved fashion in the placement area, e.g. by virtue of the tapes being aligned in a predetermined course by means of the pressure of a placement roll and the material stress present.

In accordance with one development, the fiber composite structure can be configured as fiber plastic laminate and/or as fiber metal laminate. A bottom electrode layer of the energy generating layer can be cohesively connected to a top fiber composite layer of the fiber composite structure. By way of example, the bottom electrode layer of the energy generating layer can be adhesively bonded to the top fiber composite layer. In an alternative variant, the bottom electrode layer of the energy generating layer can be cohesively connected to the top fiber composite layer by means of a welding method. By way of example, the fiber composite structure can comprise a thermoplastic which can be liquefied in layers by the action of temperature and pressure and can be cohesively connected to further components. In one concrete example, the fiber composite structure can be fabricated from a fiber reinforced thermoplastic, e.g. carbon fiber reinforced plastic. In another concrete example, the fiber composite structure can comprise alternating layers of a metal material, e.g. an aluminum alloy, and a fiber material, e.g. glass fiber reinforced plastic. In both concrete examples, the bottom electrode layer of the energy generating layer can be adhesively bonded onto the top fiber composite layer or be cohesively connected thereto in some other way.

In accordance with one development, the fiber composite structure can be configured as fiber metal laminate, wherein a bottom electrode layer of the energy generating layer can form a top fiber composite layer of the fiber composite structure. By way of example, the bottom electrode layer of the energy generating layer can comprise a metal material such as an aluminum alloy as electrode material. In this case, this layer of metal material can then simultaneously serve as the topmost metal layer of the fiber metal laminate of the fiber composite structure. By way of example, an adjacent, second electrode layer from the top can have an electrically insulating effect, e.g. a layer of glass fiber laminate.

In accordance with one development, a top electrode layer of the energy generating layer can be configured as light transmissive.

In accordance with one development, the top electrode layer can comprise indium tin oxide (ITO), i.e. a ternary composition of indium, tin and oxygen in different proportions. ITO has a thermally insulating effect, inter alia, and is particularly scratch resistant. In principle, it is likewise possible to use further suitable materials for thinfilm solar cells, such as e.g. fluorine doped tin oxide (referred to as: “fluorine tine oxide”, FTO), aluminum doped zinc oxide (referred to as: “aluminum zinc oxide”, AZO), antimony doped tin oxide (referred to as: “antimony tin oxide, ATO), graphene, etc. In one concrete example, the top electrode layer can comprise ITO, a middle layer can be configured as a polymeric heterojunction and a bottom electrode layer can comprise a metal alloy, such as an aluminum alloy, for example.

In accordance with one development, the system can furthermore comprise a sensor node. The state sensors can in each case be electrically connected to the sensor node. The sensor node can be configured to receive the state data from the state sensors and to communicate said data wirelessly to the data processing unit. The sensor node can thus serve as a local node for bundling a number of state sensors, e.g. two, three, four or more state sensors. For this purpose, the sensor node can be configured to control the state sensors by open loop or closed loop control and/or to supply them with electrical energy from the energy store and/or the energy generating layer. Furthermore, the sensor node can comprise an antenna for linking to a wireless data network that couples the sensor node and thus likewise the state sensors data technologically to the data processing unit. In alternative configurations, however, the state sensors can likewise be linked individually via a wireless link to the data processing unit. The sensor node can comprise for example a microprocessor, a microcontroller or the like, which can be part of an integrated circuit which is integrated into the sensor node and can comprise all necessary constituent parts, such as, for example, data connections to the state sensors, one or more data antennas, power lines to the state sensors, etc.

In accordance with one development, the state sensors can be connected to the sensor node in each case via an electrical line. The electrical line can be configured at least regionally as a printed line on a surface of the fiber composite structure. In this variant, the electrical lines are thus integrated into the system in a particularly space and weight saving manner. By way of example, the electrical lines can be printed directly onto a surface of the fiber composite structure. Alternatively, the electrical lines can be printed onto a flexible film, which can in turn be adhesively bonded onto the surface of the fiber composite structure or be secured thereto in some other way.

In accordance with one development, the sensor node can be configured to supply the state sensors with electrical energy from the energy store and/or the energy generating layer. For this purpose, the sensor node can comprise data and/or power lines that connect the sensor node to the state sensors, on the one hand, and to the energy store and/or the energy generating layer, on the other hand. Furthermore, the energy generating layer can be directly connected to the energy store.

In accordance with one development, the energy store and/or the sensor node can comprise a protective housing. The protective housing can be secured to an underside of the fiber composite structure. By way of example, the energy store and the sensor node can comprise individual protective housings composed of a metal material. The protective housing(s) can be secured to the fiber composite structure via releasable or permanent connections, for example, in particular as near as possible to the energy generating layer. By way of example, connection holders or pads or the like can be adhesively bonded onto the underside of the fiber composite structure. The protective housings can then be fitted to said connection holders for example by means of screws or other securing means or connection elements. The electrical lines of the state sensors can pass through openings provided therefor in the respective protective housing. Alternatively, the electrical lines can likewise be secured to the protective housings or be coupled to connections provided therefor, e.g. via a crimp connection or the like.

In accordance with one development, the protective housing can comprise an inspection flap. The protective housings can be kept closed during operation. The inspection flaps can be opened just for inspection purposes. The inspection flaps can be arranged for example on an underside of the protective housings.

In accordance with one development, the protective housing can be secured to the fiber composite structure directly below the energy generating layer.

In accordance with one development, the system can comprise a multiplicity of sensor nodes with associated state sensors. Each state sensor can be linked for example to a handful, e.g. a single digit number, of state sensors. Each sensor node can be wirelessly linked to the data processing unit individually via one or more corresponding antennas. In principle, a plurality of data processing units, including ones acting with redundancy, can furthermore be provided. By way of example, a respective group composed of in each case a plurality of sensor nodes and an associated data processing unit can form a sensor cell, wherein the system can comprise a plurality of such sensor cells, e.g. one or more sensor cells on an airfoil and one or more sensor cells on a fuselage of an aircraft. The data processing units and thus the sensor cells can in turn be connected to a central system server via a data line or a wireless connection.

In accordance with one development, the fiber composite structure can be configured as a skin panel of a fuselage and/or of an airfoil of the aircraft or spacecraft.

The above configurations and developments can be combined with one another in any desired manner, in so far as practical. Further possible configurations, developments and implementations of the invention also encompass combinations not explicitly mentioned of features of the invention described above or below in relation to the exemplary embodiments. In particular, here the person skilled in the art will also add individual aspects as improvements or supplementations to the respective basic form of the present invention.

### SUMMARY OF FIGURES

The present invention is explained in greater detail below on the basis of the exemplary embodiments indicated in the schematic figures, in which:

FIG. 1 shows a schematic view of a system for the state monitoring of a fiber composite structure of an aircraft or spacecraft in accordance with one embodiment of the invention;

FIGS. 2a and 2b show schematic sectional views of exemplary fiber composite structures from the system in FIG. 1;

FIG. 3 shows a schematic perspective view of a fiber composite structure obliquely from below with a sensor cell from the system in FIG. 1; and

FIG. 4 shows a schematic side view of an aircraft including the system.

The accompanying figures are intended to convey a further understanding of the embodiments of the invention. They illustrate embodiments and, in association with the description, serve to elucidate principles and concepts of the invention. Other embodiments and many of the advantages mentioned are evident in view of the drawings. The elements of the drawings are not necessarily shown in a manner true to scale with respect to one another.

In the figures of the drawing, identical, functionally identical and identically acting elements, features and components, unless explained otherwise are provided in each case with the same reference signs.

### DETAILED DESCRIPTION

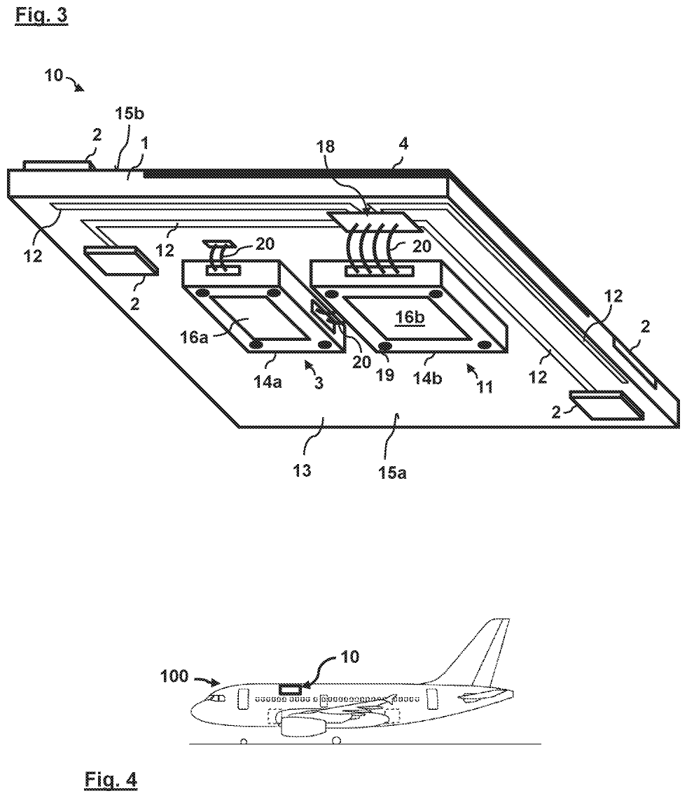

FIG. 1 shows a schematic view of a system 10 for the state monitoring of a fiber composite structure 1 of an aircraft or spacecraft 100 in accordance with one embodiment of the invention. FIG. 3 shows the fiber composite structure 1 in a schematic perspective view obliquely from below. FIG. 4 shows an aircraft with the system.

The system 10 comprises a plurality of sensor cells 22 each including a plurality of sensor nodes 11, which are in each case in wireless data communication with two cell associated data processing units 5 (one of the two data processing units 5 can serve here for example as a redundant backup unit for the case where the other data processing unit 5 fails). The data processing units 5 are in turn connected to a central system server 21 of the system 10 via electrical lines 12. The sensor nodes 11 each comprise a plurality of state sensors 2 (cf. FIG. 3) which, on and/or in the fiber composite structure 1, are configured to detect state data of the fiber composite structure 1. The fiber composite structure 1 can be in this case, for example, a skin panel of a fuselage and/or of an airfoil of the aircraft or spacecraft 100 in FIG. 4 (e.g. a passenger aircraft).

The state data detected by the state sensors 2 can comprise, for example, structural parameters of the fiber composite structure 1, such as temperature, mechanical load and/or stress or the like, damage to the fiber composite structure 1, accelerations of the fiber composite structure 1, etc. For this purpose, the state sensors 2 can comprise e.g. electronic sensors including detectors or antennas or the like, e.g. temperature sensors, acceleration sensors or piezoelectric transducers. The state sensors 2 can be arranged in a manner distributed over and in the fiber composite structure 1. In the example in FIG. 3, a total of four state sensors 2 are provided. Two of said state sensors 2 are secured on a surface 13 of an underside 15a of the fiber composite structure 1. A further state sensor 2 is fitted on an opposite top side 15b of the fiber composite structure 1. The fourth state sensor 2 is embedded into the fiber composite structure 1 (on the right in FIG. 3). By way of example, one of the state sensors 2 can be configured as an acceleration sensor. If an object in the vicinity of this state sensor 2 strikes the aircraft 100, the state sensor 2 recognizes the impact and can provide an estimation of the impact location and possibly of the affected region and/or the severity of the impact. Protective housing electric transducers, on the other hand, can be positioned e.g. within the fiber composite structure 1 and detect waves which propagate in the material and can provide a measure of resultant impact damage. During propagation through the material, said waves are influenced by discontinuities in the material, such as e.g. fractures, deformations or displacements on account of impacts or material fatigue. In this case, the propagation is influenced very specifically and the alterations in the propagated wave spectrum can be measured and analyzed in order to ascertain whether or not damage has occurred. In this way, possible damage to a fuselage or to airfoils of an aircraft 100 can be electronically recognized and assessed.

Each of the state sensors 2 is connected to the sensor node 11 via an electrical line 12, via which the state sensors 2 are supplied with electrical energy by the sensor node 11. The electrical line 12 is simultaneously configured to exchange the state data between the respective state sensor 2 and the sensor node 11, wherein said data are relayed (not depicted in FIG. 3) from the sensor node 11 once again wirelessly via an antenna to the data processing unit 5. Specifically, the electrical lines 12 in FIG. 3 are printed directly onto the surface 13 of the underside 15a of the fiber composite structure 1. In order to connect the electrical lines 12 to the corresponding state sensors 2, provision is made in part of feedthroughs through the fiber composite structure 1 (not depicted). Furthermore, the electrical lines 12 are connected to the sensor node 11 via a crimp connection 18 and connection cables 20 adjacent thereto. The sensor node 11 itself is situated together with a microcontroller and corresponding integrated circuits within a protective housing 14b composed of a metal material, which is secured to the underside 15a of the fiber composite structure 1 by means of connection elements 19 such as, for example, screws or the like. For mounting, maintenance and/or inspection purposes, the sensor node 11 furthermore has an inspection flap 16b on an underside.

The system 10 furthermore comprises an energy store 3, e.g. a (structural) battery configured to store electrical energy for the supply of the state sensors 2 in a rechargeable manner. The sensor node 11 is electrically connected to said energy store 3 for the operation of the state sensors 2. In the same way as the sensor node 11, an energy store 3, such as a rechargeable battery, also comprises a protective housing 14a composed of metal with an inspection flap 16a. The energy store 3 is in turn electrically connected via connection cables 20 to an energy generating layer 4 configured, on the fiber composite structure 1, to generate the electrical energy for the supply of the state sensors 2. In order to keep the length of the connection lines or cables as short as possible, both the energy store 3 and the sensor node 11 are secured to the fiber composite structure 1 directly below the energy generating layer 4.

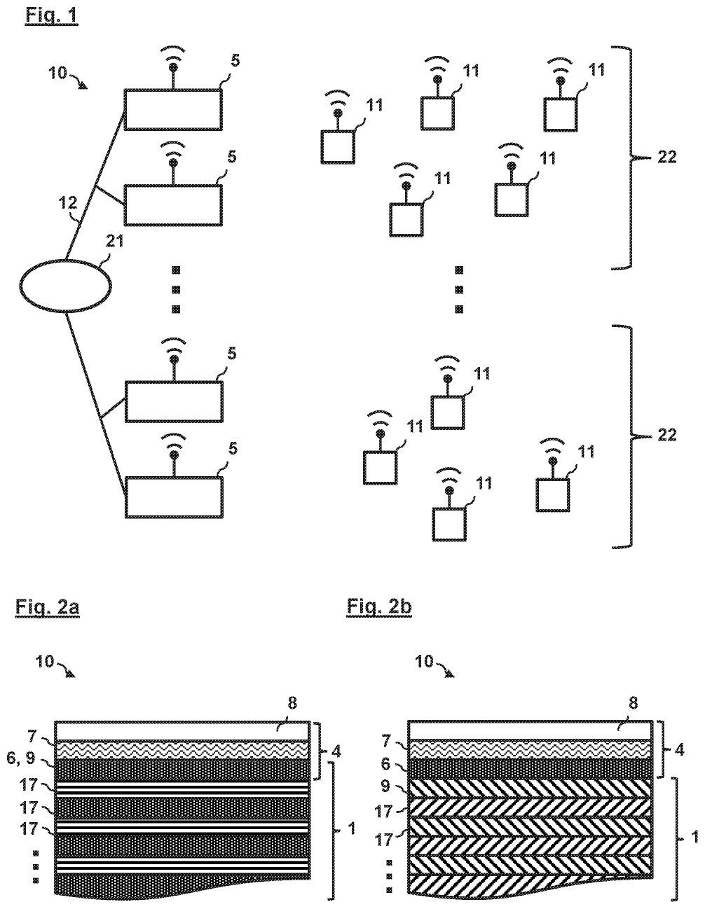

FIGS. 2a and 2b illustrate sectional views of two fiber composite structures 1 of this type together with an energy generating layer 4 situated thereon. In both examples, the energy generating layer 4 is configured as a polymeric thin film solar cell comprising a light transmissive top electrode 8 on the basis of indium tin oxide, adjacent to which there is a heterojunction, which is in turn seated on a bottom electrode 6 composed of an aluminum alloy. In the variant in FIG. 2a, the energy generating layer 4 is fabricated integrally with the fiber composite structure 1, wherein the latter consists of fiber composite layers 17 fabricated alternately from an aluminum alloy and a glass fiber laminate. Specifically, in this case, a top fiber composite layer 9 simultaneously serves as a bottom electrode 6 of the energy generating layer 4.

In the alternative example in FIG. 2b, by contrast, the energy generating layer 4 is cohesively connected to the fiber composite structure 1, e.g. by means of adhesive bonding or welding. In this case, the fiber composite structure 1 comprises a multiplicity of fiber composite layers 17 composed of a carbon fiber reinforced thermoplastic, wherein the fibers in the fiber composite layers 17 are aligned alternately in different directions (indicated by hatching in FIG. 2b).

The system 10 comprises a multiplicity of sensor nodes 11 corresponding to that in FIG. 3, which in each case communicate wirelessly with one or more associated data processing units 5 and are configured as totally autonomous with regard to the energy supply. Accordingly, small groups of state sensors 2 can be positioned in a suitable region of the primary structure of the aircraft 100 and be operated there locally by way of the associated sensor node 11 (including energy store 3 and energy generating layer 4 connected thereto). Data and power lines thus at best have to be provided in a locally highly delimited region. The sensor nodes 11 can in turn communicate wirelessly with the data processing units 5 and thus ultimately with a central system server 21, which can be provided for example at a suitable location within the aircraft 100. Inter alia, on account of this configuration of the system 10, conducting cables and thus weight and ultimately costs can be saved to a considerable extent. The state sensors 2 are operated locally in a flexible and autonomous manner, wherein the energy store 3 can compensate for fluctuations in the energy feed of the energy generating layer 4 at least to a certain degree.

In the detailed description above, various features have been summarized in one or more examples in order to improve the rigorousness of the explanation. It should be clear here, however, that the above description is merely illustrative in nature, but on no account restrictive in nature. It serves to cover all alternatives, modifications and equivalents of the various features and exemplary embodiments. Many other examples will be immediately and directly clear to the person skilled in the art on the basis of his/her expert knowledge in view of the above description.

The exemplary embodiments have been chosen and described in order that the principles underlying the invention and the application possibilities thereof in practice can be presented in the best possible way. As a result, those skilled in the art can modify and utilize the invention and its various exemplary embodiments optimally with regard to the intended purpose of use. In the claims and the description, the terms “including” and “having” are used as linguistically neutral concepts for the corresponding terms “comprising”. Furthermore, a use of the terms “a”, “an” and “one” is intended not to exclude, in principle, a plurality of features and components described in this way.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Fiber composite structure
2 State sensor
3 Energy store
4 Energy generating layer
5 Data processing unit
6 Bottom electrode layer
7 Heterojunction
8 Top electrode layer
9 Top fiber composite layer
10 System for state monitoring
11 Sensor node
12 Electrical line
13 Surface of the fiber composite structure
14a, 14b Protective housing
15a Underside of the fiber composite structure
15b Top side of the fiber composite structure
16a, 16b Inspection flap
17 Fiber composite layer
18 Crimp connection
19 Connection element
20 Connection cable
21 System server
22 Sensor cell
100 Aircraft

The invention is:

1. A system for state monitoring of a fiber composite structure comprising:
a fiber composite structure;
a plurality of state sensors which, on and/or in the fiber composite structure, are configured to detect state data of the fiber composite structure;
an energy store configured to store electrical energy to supply the state sensors in a rechargeable manner;
an energy generating layer configured, on the fiber composite structure, to generate electrical energy for the supply of the state sensors; and
a data processing unit configured for wireless data communication with the state sensors for the further processing of the detected state data.

2. The system according to claim 1, wherein the energy generating layer is configured as a polymeric thin film solar cell.

3. The system according to claim 1, wherein the energy generating layer is fabricated integrally with the fiber composite structure.

4. The system according to claim 3, wherein the fiber composite structure is configured as at least one from fiber plastic laminate and fiber metal laminate, and a bottom electrode layer of the energy generating layer is cohesively connected to a top fiber composite layer of the fiber composite structure.

5. The system according to claim 3, wherein the fiber composite structure is configured as a fiber metal laminate, and a bottom electrode layer of the energy generating layer forms a top fiber composite layer of the fiber composite structure.

6. The system according to claim 1, wherein a top electrode layer of the energy generating layer is configured as light transmissive.

7. The system according to claim 6, wherein the top electrode layer comprises indium tin oxide.

8. The system according to claim 1, further comprising:
a sensor node to which the state sensors are in each electrically connected and which is configured to receive the state data from the state sensors and to communicate said data wirelessly to the data processing unit.

9. The system according to claim 8, wherein the state sensors are each connected to the sensor node via an electrical line configured at least regionally as a printed line on a surface of the fiber composite structure.

10. The system according to claim 8, wherein the sensor node is configured to supply the state sensors with electrical energy from the energy store and/or the energy generating layer.

11. The system according to claim 8, wherein the energy store and/or the sensor node comprise a protective housing, which is secured to an underside of the fiber composite structure.

12. The system according to claim 11, wherein the protective housing comprises an inspection flap.

13. The system according to claim 11, wherein the protective housing is secured to the fiber composite structure directly below the energy generating layer.

14. The system according to claim 8, wherein the system comprises a multiplicity of sensor nodes with associated state sensors.

15. An aircraft or spacecraft comprising the system according to claim 1, wherein the fiber composite structure is configured in particular as a skin panel of a fuselage and/or of an airfoil of the aircraft or the spacecraft.

16. A system for state monitoring of a fiber composite structure comprising:
a fiber composite structure;
a first group of state sensors mounted to the fiber composite structure and configured to detect state data representative of at least one parameter of the fiber composite structure;
a second group of state sensors mounted to the fiber composite structure and configured to detect state data representative of the at least one parameter of the fiber composite structure;
a first rechargeable battery mounted to the fiber composite structure proximate to the first group of state sensors and connected to each of the state sensors in the first group by a respective electrical line mounted to the fiber composite structure, wherein the first rechargeable battery is configured to provide electrical power to the state sensors in the first group through the electrical lines;
a second rechargeable battery mounted to the fiber composite structure proximate to the second group of state sensors and connected to each of the state sensors in the second group by a respective electrical line mounted to the fiber composite structure, wherein the second rechargeable battery is configured to provide electrical power to the state sensors in the second group through the electrical lines;
a first photovoltaic module mounted to the fiber composite structure proximate the first rechargeable battery, and configured to generate electrical energy for the first group of state sensors and the first rechargeable battery;
a second photovoltaic module mounted to the fiber composite structure proximate the second rechargeable battery, and configured to generate electrical energy for the second group of state sensors and the second rechargeable battery; and
a data processing unit configured for wireless data communication with the first and second groups of state sensors and the data processing unit is configured to receive state data from the first and second group and process the received state data.

17. The system of claim 16, wherein the second rechargeable battery is not electrically connected to the first group of state sensors and the first rechargeable battery is not electrically connected to the second group of state sensors.

18. The system of claim 16, wherein the state sensors in the first and second groups include accelerometers and are configured to detect local accelerations of the fiber composite structure due to strikes on the structure.

19. The system of claim 16, wherein in the first group of the state sensors are mounted to an inside surface of the fiber composite structure and the second group of state sensors are mounted to an outside surface of the fiber composite structure.
